(19) United States
(12) Patent Application Publication
(10) Pub. No.: US 2022/0091267 A1
(43) Pub. Date: Mar. 24, 2022

(54) METHOD FOR ASCERTAINING AN OPERATING PARAMETER FOR OPERATING A SURROUNDINGS DETECTION SYSTEM FOR A VEHICLE, AND SURROUNDINGS DETECTION SYSTEM

(71) Applicant: Robert Bosch GmbH, Stuttgart (DE)

(72) Inventors: Christian Adam Knipl, Stuttgart (DE); Tom Dietrich, Stuttgart (DE)

(21) Appl. No.: 17/446,844

(22) Filed: Sep. 3, 2021

(30) Foreign Application Priority Data
Sep. 23, 2020 (DE) 102020211879.5

(51) Int. Cl. G01S 17/894; B60Q 1/00; G01S 17/86; G01S 17/931; H04N 7/18

(52) U.S. Cl. CPC G01S 17/894; B60Q 1/0023; H04N 7/183; G01S 17/931; G01S 17/86

(57) ABSTRACT

A method for ascertaining an operating parameter for operating a surroundings detection system for a vehicle. The surroundings detection system includes a projection unit and an image recording unit. The method includes a step of providing a projection signal to an interface to the projection unit, the projection signal including a control parameter for projecting a light pattern into a surrounding area of the vehicle. In a step of reading in, image data are read in via an interface to the image recording unit, the image data including the light pattern projected into the surrounding area. The method furthermore includes a step of processing the image data, using a processing specification, to ascertain the operating parameter.

### CROSS REFERENCE

The present application claims the benefit under 35 U.S.C. § 119 of German Patent Application No. DE 102020211879.5 filed on Sep. 23, 2020, which is expressly incorporated herein by reference in its entirety.

### FIELD

The present invention is directed to a method and to a control unit for ascertaining an operating parameter for operating a surroundings detection system for a vehicle and to a surroundings detection system. The present invention also relates to a computer program.

### BACKGROUND INFORMATION

With respect to autonomous or highly automated driving, today's vehicles include a plurality of driver assistance systems, which are often camera-based so that such vehicles include at least one camera or at least one camera module.

### SUMMARY

Example embodiments of the present invention provide improved methods for ascertaining an operating parameter for operating a surroundings detection system for a vehicle. Furthermore a control unit which uses these methods, corresponding computer programs, and improved surroundings detection systems are provided in accordance with example embodiments of the present invention. The measures disclosed herein allow advantageous refinements of and improvements on the basic device in accordance with the present invention.

An example embodiment of the present invention provides an option for improving, for example, a recognition and compensation of operating errors or operating impairments or parameter deviations in a surroundings detection system for a vehicle. Furthermore, for example, an operating function of the surroundings detection system may, in particular, be improved during poor visibility conditions. At the same time, a driving safety or traffic safety may be enhanced by the approach described here.

A method for ascertaining an operating parameter for operating a surroundings detection system for a vehicle is provided. The surroundings detection system includes a projection unit and an image recording unit. In accordance with an example embodiment of the present invention, the method includes a step of providing a projection signal to an interface to the projection unit, the projection signal including a control parameter for projecting a light pattern into a surrounding area of the vehicle. The method furthermore includes a step of reading in image data via an interface to the image recording unit, the image data (among other things) including the light pattern projected into the surrounding area. In a step of processing, the image data are processed, using a processing specification, to ascertain the operating parameter.

The surroundings detection system may, for example, be implemented in a vehicle in connection with driver assistance systems. The vehicle may, for example, be configured as a passenger car, as a truck, or, for example, as a commercial vehicle. As an alternative, the vehicle may also be implemented as a two-wheel vehicle. The projection unit may, for example, include at least one light source, for example a laser-based light source. The image recording unit may, for example, be implemented as a camera.

According to one specific embodiment of the present invention, the operating parameter may be ascertained in the step of processing, which may be designed to effectuate a refocusing of the image recording unit, a resharpening of an image represented by the image data, and, in addition or as an alternative, a recalibration of the image recording unit. Advantageously, in this way an instantaneous state, for example of the image recording unit, and thus a functionality thereof may be ascertained.

According to one specific embodiment of the present invention, the projection signal may be provided in the step of providing, to project the light pattern, which may represent a light point structure, a light strip structure and, in addition or as an alternative, a light point cloud, or another geometric structure. In the process, the light pattern may be projected into a vehicle-external area. The light pattern may have at least one predefined geometric property. Advantageously, an undesirable deviation during the function of the image recording unit may thus be reliably ascertained and eliminated.

Furthermore, in the step of processing, the processing specification may effectuate a comparison of at least one image parameter of the image data to a stored empirical value to obtain a comparison result, it being possible to ascertain the operating parameter using the comparison result. The empirical value may have a predefined relationship to the control parameter of the projection signal. Advantageously, it may thus be established whether the image recording unit is, for example, set to be sharp in a plurality of image areas.

According to one specific embodiment of the present invention, in the step of processing, the processing specification may effectuate a calculation of at least one blur value in an image represented by the image data, it being possible to ascertain the operating parameter using the blur value. Advantageously, it is thus possible, for example, to subsequently cope with an existing blur by actuating an autofocus function.

Furthermore, the processing specification in the step of processing may be designed to ascertain an impulse response function. Advantageously, the point spread function and, in addition or as an alternative, the impulse response function for at least one light point may be ascertained.

According to one specific embodiment of the present invention, in the step of providing, the projection signal may be provided to be able to project the light pattern into an object space in the surroundings of the vehicle. In particular, the object space may be situated outside the vehicle.

According to one specific embodiment of the present invention, the steps of the method may be carried out repeatedly and, in addition or as an alternative, continuously. In this way, for example, the image recording unit may be recalibrated at time intervals and, in addition or as an alternative, a setting of the image recording unit may be updated.

This method may, for example, be implemented in software or hardware or in a mixed form made up of software and hardware, for example in a control unit.

The present invention furthermore provides a control unit which is designed to carry out, control or implement the steps of one variant of a method described here in corresponding units. The object of the present invention may also be achieved quickly and efficiently by this embodiment variant of the present invention in the form of a control unit.

In accordance with an example embodiment, the control unit may include at least one processing unit for processing signals or data, at least one memory unit for storing signals or data, at least one interface to a sensor or an actuator for reading in sensor signals from the sensor or for outputting control signals to the actuator and/or at least one communication interface for reading in or outputting data which are embedded in a communication protocol. The processing unit may be a signal processor, a microcontroller or the like, for example, it being possible for the memory unit to be a Flash memory, an EEPROM or a magnetic memory unit. The communication interface may be designed to read in or output data wirelessly and/or in a hard-wired manner, a communication interface which may read in or output hard-wired data being able to read in these data, for example electrically or optically, from a corresponding data communication line or being able to output these in a corresponding data communication line.

A control unit within the present context may be understood to mean an electrical device which processes sensor signals and outputs control and/or data signals as a function thereof. The control unit may include an interface which may be designed as hardware and/or software. In the case of a hardware design, the interfaces may, for example, be part of a so-called system ASIC which includes a wide variety of functions of the control unit.

However, it is also possible for the interfaces to be separate integrated circuits, or to be at least partially made up of discrete elements. In the case of a software design, the interfaces may be software modules which are present on a microcontroller, for example, alongside other software modules.

In addition, a computer program product or computer program is advantageous, having program code which may be stored on a machine-readable carrier or memory medium such as a semiconductor memory, a hard disk memory or an optical memory, and which is used to carry out, implement and/or control the steps of the method according to one of the specific embodiments described above, in particular if the program product or program is executed on a computer or a device.

Furthermore, a surroundings detection system for a vehicle is described, the surroundings detection system including a projection unit for projecting a light pattern into a surrounding area of the vehicle, an image recording unit for recording image data which represent the light pattern projected into the surrounding area, and a control unit in an aforementioned variant, the control unit being connected to the projection unit and the image recording unit in a signal transfer-capable manner.

Advantageously, the control unit may be designed to operate the surroundings detection system. Advantageously, the surroundings detection system may furthermore be cost-effectively implemented since, for example, a number of components are preserved.

According to one specific embodiment of the present invention, the projection unit may be designed as a LIDAR system. Advantageously, the projection unit may, for example, be used in the vehicle for a multitude of functions.

Furthermore, the projection unit may be situated adjoining a headlight of the vehicle, for example integrated into the headlight of the vehicle, or adjoining the image recording unit. Advantageously, an object space to be illuminated may be illuminated and detected by a suitable position of the projection unit and, in addition or as an alternative, of the image recording unit.

Exemplary embodiments of the present invention are shown in the figures and are described in greater detail below.

### BRIEF DESCRIPTION OF THE DRAWINGS

FIG. 1 shows a partially schematic representation of a vehicle including a surroundings detection system, in accordance with an example embodiment of the present invention.

FIG. 2 shows a flowchart of one exemplary embodiment of a method for ascertaining an operating parameter for operating a surroundings detection system for a vehicle, in accordance with an example embodiment of the present invention.

FIG. 3 shows a block diagram of a control unit according to one exemplary embodiment of the present invention.

### DETAILED DESCRIPTION OF EXAMPLE EMBODIMENTS

In the following description of favorable exemplary embodiments of the present invention, identical or similar reference numerals are used for similarly acting elements shown in the different figures, and a repeated description of these elements is dispensed with.

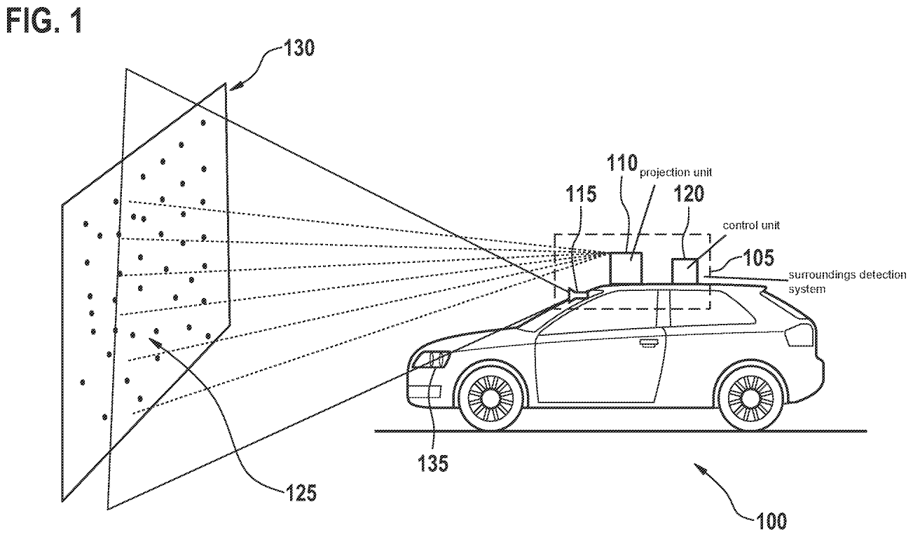

FIG. 1 shows a partially schematic representation of a vehicle 100 including a surroundings detection system 105. According to this exemplary embodiment, vehicle 100 is implemented as a passenger car. As an alternative, vehicle 100 is also implementable as a commercial vehicle or as a truck. Surroundings detection system 105 is usable, for example, in connection with cell phones, in the consumer area, but for example also in connection with safety systems or for scientific applications. In the illustration shown here, surroundings detection system 105 is used in connection with at least one driver assistance system of vehicle 100. For this purpose, surroundings detection system 105 includes a projection unit 110, an image recording unit 115, as well as a control unit 120. Projection unit 110 is designed to project a light pattern 125 into a surrounding area 130 of vehicle 100. Image recording unit 115 is designed to record image data which represent light pattern 125 projected into surrounding area 130. Control unit 120 is connected to projection unit 110 and image recording unit 115 in a signal transfer-capable manner and designed to control or carry out a method for ascertaining an operating parameter for operating surroundings detection system 105, as is explained in greater detail in one of the following figures. According to this exemplary embodiment, projection unit 110 is only optionally designed as a LIDAR system and is, for example, situated adjoining image recording unit 115. As an alternative, projection unit 110 is situated adjoining or integrated into a headlight 135 of vehicle 100.

In other words, the approach described here provides an option for setting or carrying out an autofocus and/or a calibration of image recording unit 115 and/or a, for example software-based, resharpening of camera images, using projected light structures which are referred to as light patterns 125 here.

According to this exemplary embodiment of the present invention, a camera, which is referred to as an image recording unit 115 here, is used for driver assistance systems and/or in connection with highly automated driving. As a result, it supplies a sharp image to further processing algorithms over a very long service life. The image is, in particular, sharp when an image plane of a lens system of image recording unit 115 coincides with a camera sensor. If this is not sufficiently the case, filters may subsequently be used in the downstream image processing process to enhance the image sharpness, in order to improve a detection quality of the algorithms. If the image plane is, for example, situated above or beneath the sensor, the image sharpness decreases. However, there is a tolerance range around the image plane in which the image is still sharp enough, which is referred to as depth of focus (abbrev. DOF).

During the calibration procedure, a relationship between image information and real world geometry should be known. This is ensured, for example, by an intrinsic calibration at the factory and by an extrinsic calibration at the customer, so that each pixel in the image is assigned to a real angular range. For the calibration of image recording unit 115, an image of locally known light sources is recorded, for example, which is referred to as intrinsic calibration. The spatial position of the light sources should be known in the process with sufficiently high precision. With the aid of a comparison of the position of the light sources and the position of the imaged light sources in the camera image, finally a calibration reference is established.

Against this background, image recording unit 115 for vehicle 100 is provided by the described approach, image recording unit 115 including an autofocus function, for example. As a result of the approach described here, additionally different imaging errors of the optics are corrected by software. For this purpose, the imaging properties and imaging errors are ascertained, such as for example the impulse response function as a function of a field angle.

According to this exemplary embodiment, projection unit 110 includes an emitter. The emitter emits, for example, the point cloud having known positions, which is detected by image recording unit 115 and is used, for example, for a calibration and/or for a resharpening. The emitter for structured light patterns 125 is, for example, designed as a LIDAR system which is already implemented in vehicle 100, which is also referred to as “sensor fusion.” It includes a calibrated infrared light source, for example, and may generate a 3D point cloud from a time-of-flight measurement of the LIDAR signals. This would enable a calibration of the video system while driving or during every vehicle start. For image recording unit 115, which is implemented as a video system, for example, to be able to operate using a LIDAR signal, the optics should be designed in a transmitting manner, for example with the aid of a lens system and a color filter mask, and/or the camera sensor should be designed in an absorbing manner, for the infrared light wavelength of the LIDAR system, also referred to as NIR light wavelength. It is possible that LIDAR and camera calibrate and carry out plausibility checks with respect to one another. The LIDAR light sources emit laser beams invisible to people into a large spatial angular range. The LIDAR system measures the time of flight of the laser pulses and calculates therefrom a precise location coordinate of the reflected surface for each laser pulse. A modern LIDAR system is able to emit a very large number of laser points, for example with the aid of a suitable local sampling rate, so that the surroundings are described by a dense point cloud in three dimensions.

As an alternative, the emitter for structured light patterns 125 is configured as a separate element, which is situated, for example, next to image recording unit 115 or at headlight 135. When it is attached directly next to image recording unit 115, a parallax between the emitting unit and image recording unit 115 is reduced. The emitter optionally operates in the visible spectral range, for example during every startup process of vehicle 100. In the case of the LIDAR variant, it is verifiable that the lens system as well as the color filter mask of the camera sensor allows the LIDAR wavelength to pass. Due to the transmission properties of the lens system and the color filter array of the sensor, a capturing of the LIDAR signal in the video camera is thus verifiable.

Furthermore, as an alternative, the emitter for structured light patterns 125 is configured or configurable to be removable, instead of being fixedly installed at vehicle 100. In this case, an accordingly precise mount is present at vehicle 100. In the case of a visit to a repair shop, a corresponding projection unit is, for example, temporarily attachable and subsequently removable again for calibrating image recording unit 115.

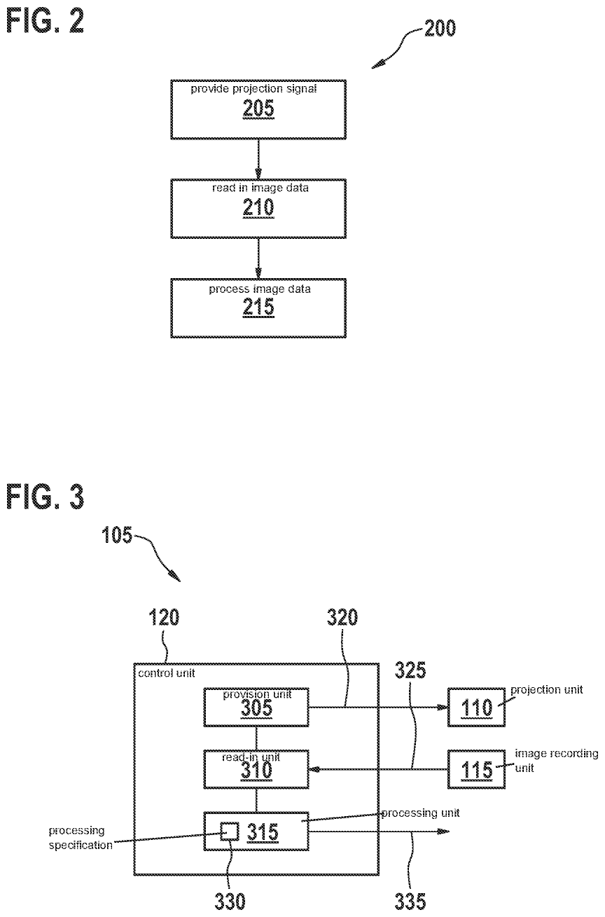

FIG. 2 shows a flow chart of a method 200 for ascertaining an operating parameter for operating a surroundings detection system for a vehicle according to one exemplary embodiment. In the process, method 200 may be carried out in a vehicle including a surroundings detection system, as was described in FIG. 1. Method 200 includes a step 205 of providing, a step 210 of reading in, and a step 215 of processing. In step 205 of providing, a projection signal is provided to an interface to the projection unit. The projection signal includes a control parameter for projecting the light pattern into the surrounding area of the vehicle. In step 210 of reading in, image data are read in via an interface to the image recording unit. In the process, the image data include, among other things, the light pattern projected into the surrounding area. Furthermore, in step 215 of processing, the image data are processed, using a processing specification, to ascertain the operating parameter.

According to this exemplary embodiment, steps 205, 210, 215 of method 200 are carried out repeatedly and/or continuously. In this way, an updating at time intervals is made possible, for example, so that the operating parameter remains up-to-date. By repeating steps 205, 210, 215, in other words a control loop is made possible, for example. Optionally, the projection signal is provided in step 205 of providing to project the light pattern into an object space in the surroundings of the vehicle. The object space is situated vehicle-externally, for example at a front of the vehicle. In the process, the light pattern represents a light point structure, a light strip structure and/or a light point cloud, or another geometric structure. Furthermore, optionally, in step 215 of processing the operating parameter is ascertained, which is designed to effectuate a refocusing of the image recording unit, a resharpening of an image represented by the image data, and a recalibration of the image recording unit. For this purpose, for example, processing specification in step 215 of processing effectuates a comparison of at least one image parameter of the image data to a stored empirical value to obtain a comparison result. According to this exemplary embodiment, the operating parameter is ascertained using the comparison result. In addition or as an alternative, the processing specification effectuates a calculation of at least one blur value in an image represented by the image data. In this case, the operating parameter is ascertained using the blur value. The processing specification is designed, for example, to ascertain an impulse response function. According to this exemplary embodiment, it is ascertained in each case for at least one light point in the object space.

FIG. 3 shows a block diagram of a control unit 120 according to one exemplary embodiment. Control unit 120 is usable, for example, in a vehicle, as was described in FIG. 1, and is accordingly configured, for example, as part of a surroundings detection system 105. Control unit 120 is designed in the process to execute and/or control the steps of the method, as was described, for example, in FIG. 2. For this purpose, according to this exemplary embodiment control unit 120 includes a provision unit 305, a read-in unit 310, and a processing unit 315. Provision unit 305 is designed to provide a projection signal 320 to an interface to projection unit 110. Projection signal 320 includes a control parameter for projecting a light pattern into a surrounding area of the vehicle. Read-in unit 310 is designed to read in image data 325 via an interface to image recording unit 115. In the process, image data 325 include, among other things, the light pattern projected into the surrounding area. Furthermore, processing unit 315 is designed to process image data 325, using a processing specification 330, to ascertain operating parameter 335.

Exemplary embodiments and background information of exemplary embodiments are explained or introduced again hereafter in other words with reference to the above-described figures.

For example, surroundings detection system 105 is usable in connection with safety-relevant functions of vehicle 100. According to one exemplary embodiment, a light source is installed in vehicle 100, for example as part of projection unit 110, which projects precise structures, such as points, a point cloud or strips, referred to as light patterns 125 here, onto the outside world. Light pattern 125, in turn, is detected by image recording unit 115 for, for example, driver assistance systems or highly automated driving and, for example, a sharpness of the imaged structures is compared to a stored empirical value. For example, the blur or at least an imaging error in the image is calculated from the obtained pieces of information. Surroundings detection system 105 thus ascertains a degree of sharpness in different image areas. The obtained information is used, for example, to decide whether image recording unit 115 should be refocused. The refocusing process is also supervisable using a control loop.

Optionally, a point spread function (PSF, impulse response function, or the absolute value of the PSF) of the optics is approximately ascertained, using light pattern 125, for example. This may be carried out simultaneously for many points in the object space. The obtained information, such as for example a location-dependent PSF, is used, for example, for enhanced resharpening of the image.

In other words, the light source is installed in vehicle 100 which projects precise structures onto the outside world, which is, again optionally, detected by an image recording unit 115 for driver assistance systems or highly automated driving over an entire service life of vehicle 100. Control unit 120, which is also referred to as a processing unit, may carry out corrections in the intrinsic and/or extrinsic calibration of image recording unit 115 from the pieces of information of the image positions of the light points in the camera image. In this way, a setpoint value of the light point positions may be compared to an actual value, for example during delivery from the factory. Image recording unit 115 detects these structures and compares them, for example, to their empirical value which, for example, was recorded by time-of-flight measurement of the laser pulses by a LIDAR system integrated into vehicle 100. Image recording unit 115 is thus calibrated to the LIDAR signal, and it is checked whether its calibration continues to be correct. Furthermore, it is optionally continuously recalibrated in the field, for example during a use by private persons.

The advantages are, for example, an increased quality of the resharpening by software, against the background that the overall system is considered instead of only a lens system. Furthermore, it is advantageous that variations in the series production of the overall system have a lesser influence since each system calibrates itself, and always an instantaneous state is ascertained, instead of that of the manufacturing date. The further advantage is that an increased availability of an autofocus is made possible, for example at night and/or in the case of low contrast. Furthermore, a confidence that image recording unit 115 is sufficiently sharp in all image areas is increased. The approach described here furthermore allows camera defects or failed image areas, for example imaging problems, to be identified, as well as an accuracy, due to for example a simpler calibration of the overall system, to be increased. In addition, a higher safety and an improved comfort of the driver assistance functions are made possible, for example due to a higher confidence of algorithms. Corrections of a change of the intrinsics are only optionally possible via the temperature and service life effects, by which a higher precision is also achieved over the service life.

As a result of the described approach, an alternative to an intrinsic calibration used thus far is created. Thus far, the intrinsic calibration is cost-intensive and associated with a complex measuring stand. Furthermore, it is time-intensive and subject to technical limitations. Especially an influence of, for example, a windshield, such as for example an optical surface, rough tolerances and process fluctuations of the glass shape and/or glass quality, may thus reduce a precision of calibrations. This effect occurs in a particularly pronounced manner in an “edge region” of a camera image, particularly in the case of large aperture angles. To nonetheless ensure the precision of the calibration, complex and additional calibration methods which reduce the windshield effect may thus be dispensed with. When an image recording unit 115 or a windshield is replaced in the repair shop, for example, complex calibration methods would not be an option since every repair shop would have to keep expensive and complex fixtures available. In this way, it is also not necessary to accept a lower precision of the calibration. A confidence or an accuracy of the information of algorithms during the estimation of real world coordinates may thus be increased, or at least maintained, so that image recording unit 115 may advantageously contribute to the avoidance of accidents. The intrinsic calibration of image recording unit 115 additionally changes via the temperature. A conventional approach is, for example, to simulate the typical change of the intrinsics via the temperature, store it in the camera, and readjust it, for example, with the aid of a temperature sensor. The intrinsics may also change irreversibly over the service life, for example due to moisture and/or aging.

A software correction of the image sharpness is usually subject to technical limitations. If every image recording unit 115 is designed with the same correction filter, it would not or would hardly be possible to calibrate out variations in the series production of the lens systems, so that the quality of image correction and resharpening could be lower, which is avoided by the approach described here. Furthermore, the approach described here reduces the complexity which, for example, would be associated with a storage of a separate correction by a calibration of every single image recording unit 115. Different optical effects are calibrated out by the described approach. These optical effects are, for example, (opto)mechanical changes which, for example, were effectuated over a service life or by a change in the environmental conditions, for example parasitic imaging properties generated by the windshield or the cover glass in front of the camera system, or for example a blur due to scattering of particles or droplets in the air, such as for example light fog, haze and/or dust.

Against the background that image areas offer little to no contrast, the approach described here is advantageous. This means that the surroundings detection system 105 is also usable in poorly illuminated situations, such as for example while driving at night, so that a driving safety, for example with the aid of a brake assistance system or lane change assistance system, remains in effect.

If one exemplary embodiment includes an “and/or” linkage between a first feature and a second feature, this should be read in such a way that the exemplary embodiment according to one specific embodiment includes both the first feature and the second feature, and according to an additional specific embodiments includes either only the first feature or only the second feature.

What is claimed is:

1. A method for ascertaining an operating parameter for operating a surroundings detection system for a vehicle, the surroundings detection system including a projection unit and an image recording unit, the method comprising the following steps:
providing a projection signal to an interface to the projection unit, the projection signal including a control parameter for projecting a light pattern into a surrounding area of the vehicle;
reading in image data via an interface to the image recording unit, the image data including the light pattern projected into the surrounding area; and
processing the image data, using a processing specification, to ascertain the operating parameter.

2. The method as recited in claim 1, wherein, in processing step, the operating parameter is ascertained, which is configured to effectuate a refocusing of the image recording unit, and/or a resharpening of an image represented by the image data, and/or a recalibration of the image recording unit.

3. The method as recited in claim 1, wherein, in the providing step, the projection signal is provided to project the light pattern, which represents a light point structure and/or a light strip structure and/or a light point cloud and/or another geometric structure.

4. The method as recited in claim 1, wherein, in the processing step, the processing specification effectuates a comparison of at least one image parameter of the image data to a stored empirical value to obtain a comparison result, the operating parameter being ascertained using the comparison result.

5. The method as recited in claim 1, wherein, in the processing step, the processing specification effectuates a calculation of at least one blur value in an image represented by the image data, the operating parameter being ascertained using the blur value.

6. The method as recited in claim 5, wherein, in the processing step, the processing specification is configured to ascertain an impulse response function.

7. The method as recited in claim 1, wherein, in the providing step, the projection signal is provided to project the light pattern into an object space in the surrounding area of the vehicle.

8. The method as recited in claim 1, wherein the steps of the method are carried out repeatedly and/or continuously.

9. A control unit configured to ascertain an operating parameter for operating a surroundings detection system for a vehicle, the surroundings detection system including a projection unit and an image recording unit, the control unit configured to:
provide a projection signal to an interface to the projection unit, the projection signal including a control parameter for projecting a light pattern into a surrounding area of the vehicle;
read in image data via an interface to the image recording unit, the image data including the light pattern projected into the surrounding area; and
process the image data, using a processing specification, to ascertain the operating parameter.

10. A non-transitory machine-readable memory medium on which is stored a computer program for ascertaining an operating parameter for operating a surroundings detection system for a vehicle, the surroundings detection system including a projection unit and an image recording unit, the computer program, when executed by a computer, causing the computer to perform the following steps:
providing a projection signal to an interface to the projection unit, the projection signal including a control parameter for projecting a light pattern into a surrounding area of the vehicle;
reading in image data via an interface to the image recording unit, the image data including the light pattern projected into the surrounding area; and
processing the image data, using a processing specification, to ascertain the operating parameter.

11. A surroundings detection system for a vehicle, the surroundings detection system comprising:
a projection unit configured to project a light pattern into a surrounding area of the vehicle;
an image recording unit configured to record image data which represent the light pattern projected into the surrounding area; and
a control unit connected to the projection unit and the image recording unit in a signal transfer-capable manner, the control unit configured to ascertain an operating parameter for operating the surroundings detection system for the vehicle, the control unit configured to:
provide a projection signal to an interface to the projection unit, the projection signal including a control parameter for projecting a light pattern into a surrounding area of the vehicle;
read in image data via an interface to the image recording unit, the image data including the light pattern projected into the surrounding area; and
process the image data, using a processing specification, to ascertain the operating parameter.

12. The surroundings detection system as recited in claim 11, wherein the projection unit is a LIDAR system.

13. The surroundings detection system as recited in claim 11, wherein the projection unit is situated adjoining or integrated into a headlight of the vehicle or adjoining the image recording unit.
